(19) United States
(12) Patent Application Publication
(10) Pub. No.: US 2024/0297905 A1
(43) Pub. Date: Sep. 5, 2024

(54) METHOD FOR ESTABLISHING REINFORCED COMMUNICATION BETWEEN TWO DEVICES

(71) Applicant: Romain DAUMONT, Paris (FR)

(72) Inventor: Romain DAUMONT, Paris (FR)

(21) Appl. No.: 18/578,382

(22) PCT Filed: Jul. 8, 2022
(86) PCT No.: PCT/EP2022/069128

§ 371 Date: Jan. 11, 2024

(30) Foreign Application Priority Data
Jul. 13, 2021 (FR) FR2107617

(51) Int. Cl. H04L 65/1069; H04L 67/141; H04N 7/14; H04W 4/02

(52) U.S. Cl. CPC H04L 65/1069; H04L 67/141; H04N 7/147; H04W 4/027

(57) ABSTRACT

A method for establishing communication between a first user of a first device and a second user of a second device, includes establishing a bidirectional data exchange channel between the first device and the second device; for at least the first device continually acquiring non-audio data relating to an action of the first user; continually transmitting the data acquired by the first device to the second device; returning the data to the second user via the second device on the basis of the data trend, wherein the communication is considered to be established if the trend in the data returned to the second user corresponds to a predetermined plot for a predetermined duration, referred to as the activation duration, the activation duration being greater than or equal to 10 seconds.

### TECHNICAL FIELD OF THE INVENTION

The technical field of the invention is that of telecommunications.

The present invention relates to a method for establishing communication between two devices.

In the invention, both devices are intended to be used by users. The invention therefore also relates to the establishment of communication between users intermediated by devices.

### TECHNOLOGICAL BACKGROUND OF THE INVENTION

In the state of the art, there are many devices for establishing communication between two devices. Communication is established for a variety of purposes covering all aspects of life, from leisure to professional activities. It has to be said that the most common way of establishing intermediated communication between two users is to use a mobile phone, also referred to as a smartphone. In periods of limited travel, such as during a pandemic, teleworking becomes more widespread and other means of video-conferencing are used. These other means are at least tablets and computers.

All these means have been designed and adapted for verbal communications, that is to transmit voice, and to a lesser extent, not only verbal when video is added to the audio. Despite the distance, these means make it possible to reproduce an atmosphere of inter-human communication that we would like to be as close as possible to real face-to-face interaction, in other words non-intermediated communication.

This is sufficient in most cases where voice is sufficient to transmit information that the users wish to exchange. However, there are situations where voice is unavailable or unsuitable for transmitting the relevant information.

Examples of such situations include accidents in which the victims are unable to speak. There are devices for locating a missing person, for example under a snow avalanche. In this case, a first device called a transmitter belonging to a buried person emits a signal of a particular frequency detected by a second device called a receiver over a distance interval around the device of the missing person, in order to be able to rescue them in time.

More generally, there are devices such as mobile telephones, used on a daily basis, which enable their users to be located. Thus, when such a user goes missing or is in a situation of danger, it is possible to locate them by virtue of their mobile phone. However, locating a user does not tell you whether they are still alive. The user may only be able to move some of their limbs without being able to speak or call for help, and/or the device and user may be a significant distance apart. In such a case, the device is saved but not the user, partly because looking for the user has been stopped on the assumption that they were with their device. This is currently the best that can be done in terms of location. So there is a need to know whether a person is still showing signs of life, even in a critical condition. In other words, there is a need to qualify a location.

Without going as far as such dramatic situations, there are situations wherein it may be desirable to be able to measure attention and/or responsivity of an interlocutor. Such situations are, for example:
A learning situation wherein a teacher wishes to know the degree of availability of one or more pupils, for example to take a break or go into a subject in greater depth;
A remote diagnosis situation wherein a doctor wishes to measure a patient's cognitive faculties, for example to determine whether the patient is feeling faint;
A normal conversation wherein interlocutors wish to assess their level of investment.

In the case of a normal conversation, the majority of applications available today enable instant communication to be established. Although advantageous for rapid communication, these applications do not require prolonged attention on the part of users to communicate or consent to establish a communication. For example, as soon as a first user sends a message via a device, it is directly received by one or more other devices, without prior authorisation from the user(s). This can be perceived as intrusive and cause visual and/or noise pollution. There is a need to establish voluntary and reciprocal communications requiring a higher level of consent than in the case previously described.

In the state of the art there is no solution other than resorting to voice communication.

### SUMMARY OF THE INVENTION

The invention offers a solution to the problems previously discussed.

One aspect of the invention thus relates to a method for establishing enhanced communication between a first user of a first device and a second user of a second device including the following steps of:
Establishing a bidirectional data exchange channel between the first device and the second device;
For at least the first device:
   Continuously acquiring non-audio data relating to an action of the first user;
   Continuously transmitting the data acquired by said first device to the second device;
   Returning the data transmitted by the second device to the second user as a function of the time course of the data;
      And in that the communication is considered to be established if the time course of the data returned to the second user corresponds to a predetermined scheme for a predetermined period of time referred to as the establishment period of time, the establishment period of time being greater than or equal to 10 seconds.

Advantageously, the invention makes it possible to set up enhanced communication. Enhanced communication between two devices is any communication requiring additional steps compared with conventional communication between two devices. In conventional communication, communication is considered to be established when the parties to the communication become able to exchange information, whether they do so or not. For example, in the case of a voice conversation, voice being one type of data among others, communication is established as soon as the called party picks up the receiver. In the invention, steps are added to ensure that the parties are available to receive the information exchanged. This availability can be interpreted as the ability to receive and understand a message which can be transmitted with an improved compliant rate of reception via enhanced communication according to the invention.

As regards the notion of continuity, by “continuously” it is meant that measurements are made according to a time interval called the refresh interval. Such an interval is in the order of one millisecond or a few seconds at most. In the example of a scheme based on the pressure of a finger on the screen, this amounts to measuring pressure of the finger on the screen at a frequency which is the inverse of the refresh interval.

Thus, a user has to pay more attention than for instant communication, making it possible to prove that he is alive, for example, or simply to take part in a normal discussion between two interlocutors.

According to one embodiment, establishment of communication between both devices is interrupted if the predetermined scheme is interrupted.

According to another embodiment, establishment of communication between both devices is interrupted if the predetermined scheme is interrupted for a predetermined period of time referred to as the interruption period of time. A predetermined period of time is a configuration piece of data which is, for example: hard-coded in the application, read via a configuration file, entered via a configuration interface, or obtained via a request.

Furthermore, according to one embodiment, if the period of time of the interruption of the scheme is less than the so-called interruption period of time, then the establishment of the communication resumes.

According to one embodiment, when the enhanced communication is established, the user of the first communication device transmits data of the type formed by at least one of the following types: image, text, sound.

According to one embodiment, acquiring, transmitting and returning the non-audio data are carried out by both devices and the enhanced communication is considered to be established if the time course of the non-audio data received by both devices corresponds to the predetermined scheme during the establishment period of time.

According to one embodiment, the continuously acquired data are of a type belonging to the set comprising the following elements:
Video data: the predetermined scheme corresponding to an anatomical movement;
Data from an accelerometer, the predetermined scheme corresponding to a movement of a device along at least one defined axis;
Data relating to a contact on a screen included in either of both devices and the predefined scheme being a time course of the contact, the time course being measured in pressure and/or location.

According to one embodiment, the bidirectional data exchange channel between the first device and the second device is established via a third device.

According to one embodiment, the establishment period of time is between ten and sixty seconds.

According to one advantageous embodiment, communication between both devices is established via the Internet network. This embodiment enables two devices to enter into communication by virtue of different mobile telephony standards such as 3G, 4G or by virtue of the Lora long-range and low-speed communication protocol from any location and thus to know whether a user can give a sign of life even when very far away from that user.

According to one advantageous embodiment, the bidirectional data exchange channel between the first device and the second device is established according to the WebSocket® application protocol. Thus, a device can receive data from a server or another device without making requests. This enhances efficiency of data exchange both in terms of bandwidth use and interactivity: the piece of data is exchanged as soon as it is available and only when it is available.

According to one advantageous embodiment, communication between the first device and the second device is established by virtue of the hypertext transfer protocol secure. This embodiment makes it possible to establish secure communication and not to be limited by firewalls.

Furthermore, the invention comprises a system comprising at least a first device and a second device configured to implement the previously mentioned method.

According to one embodiment, the system comprises a third device configured to establish the bidirectional channel between the first device and the second device.

Another aspect of the invention relates to a computer program product comprising instructions which, when the program is executed by a computer, cause the same to implement the steps of the method previously mentioned.

The invention and its different applications will be better understood upon reading the following description and upon examining the accompanying figures.

### BRIEF DESCRIPTION OF THE FIGURES

The figures are set forth by way of indicating and in no way limiting purposes of the invention.

FIG. 1 shows a system implementing enhanced communication according to the invention between two devices

FIG. 2 shows a block diagram of a method for implementing enhanced communication according to the invention between two devices.

### DETAILED DESCRIPTION

The figures are set forth by way of indicating and in no way limiting purposes of the invention.

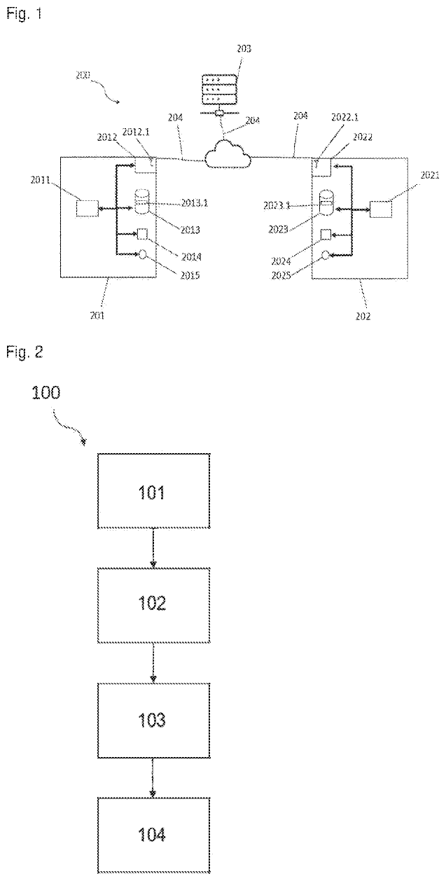

FIG. 1 represents a system 200 for establishing enhanced communication between two devices 201 and 202.

Enhanced communication between two devices is understood to be any communication requiring additional steps compared with conventional communication between two devices. In a conventional communication, the communication is considered to be established when the parties to the communication become able to exchange information, whether they do so or not. For example, in the case of a voice conversation, voice being one type of data among others, the communication is considered to be established as soon as the called party picks up the receiver. In the invention, steps are added to ensure that the parties are available to receive the information exchanged.

The system 200 includes two devices:
A first mobile device 201 used by a first user not represented;
A second mobile device 202 used by a second user not represented;
   And may include a third device 203, for example a server.

According to one embodiment, the system 200 comprises a plurality of mobile devices each used by a user. The plurality of mobile devices comprises a number N of mobile devices. N being greater than or equal to 3. For example, N is in the range [3; 10000]. For example, N is equal to 1000, 2000, 3000, 4000, 5000 or 10000.

The devices 201 and 202 each include at least:
A network interface, 2012 and 2022 respectively, including an antenna, 2012.1 and 2022.1 respectively;
A memory, 2013 and 2023 respectively
A microprocessor, 2011 and 2021 respectively
means for acquiring and reproducing the data to be transmitted.

According to the alternatives of the invention, the data acquisition means are
A touch screen;
One or more push buttons;
A camera, 2015 and 2025 respectively and/or
An accelerometer; 2014 and 2024 respectively;

By accelerometer, it is meant here a sensor which is attached to a device and which makes it possible to measure linear non-gravitational acceleration of this device. In practice, this is referred to as an accelerometer even when it is actually three sensors that measure linear accelerations along three orthogonal axes.

FIG. 1 shows that each storage memory, 2013 and 2023 respectively, of each device, 201 and 202 respectively, includes at least one zone, 2313.1 and 2023.1 respectively, for an instruction code corresponding to the implementation of the method according to the invention.

According to the alternatives of the invention, the means for reproducing the data are one or more colour diodes or preferably a screen.

The first and second devices 201 and 202 may each be, independently of each other:
A computer;
A pager; or
A tablet; or
A mobile phone, of the smartphone type for example.

The server 203 enables a bidirectional exchange channel to be established between the first and second devices 201 and 202. The server 203 thus plays an intermediary role between the first and second mobile devices.

In another embodiment, the system 200 comprises only the first device 201 and the second device 202.

FIG. 2 shows a block diagram representation of a method 100 for establishing so-called enhanced communication between at least two users, each using a first device 201 and a second device 202 respectively. The enhanced communication method between two devices 201 and 202 comprises several steps. A first step consists in establishing 101 a bidirectional exchange channel between the first device 201 and the second device 202.

In one preferred alternative, this communication channel is established via the server 203 and through the Internet network.

To connect to the Internet network, each of both devices 201 and 202 comprises, independently of each other, a wired or wireless network interface: when a device comprises a wired interface, it connects to the Internet network preferably via the Ethernet protocol. When a device comprises a non-wired interface, it can connect to the Internet via 3G, 4G, Wifi® or Lora standards, for example. Establishing a connection via an internet network advantageously enables two devices to be connected from any location and any distance between both devices.

When the devices are connected via the Internet network, the bidirectional exchange channel is preferably established by virtue of the WebSocket® protocol at the application layer associated with the hypertext transfer protocol secure (https). Use of the hypertext transfer protocol secure makes it possible to secure exchanges between both devices 201 and 202. This use also enables that data transmitted between both devices are not blocked by filtering rules. Indeed, these are standard protocols that are well accepted by networks.

The invention can be implemented simply by using http or https. In this case, data are exchanged from a server to a device in “pull” mode, during which a device sends requests to a server to receive new data.

In a preferred embodiment, the WebSocket® protocol makes it possible to operate in “push” mode wherein a device receives data from a server without the device sending requests to obtain these data.

In another embodiment, the bidirectional exchange channel between the devices 201 and 202 is established by virtue of the Bluetooth® communication standard when both devices 201 and 202 are less than 100 m apart and cannot communicate via an Internet network.

In yet another embodiment, the mobile devices are configured to behave each other as servers and can therefore communicate directly via the Internet.

A second step of the method consists, for at least a first device among both mobile devices 201 and 202, for example the first mobile device 201, in continuously acquiring 102 data 204 relating to an action of the first user. The data 204 are preferably non-audio data, for example video data without sound, data from an accelerometer included in the first mobile device 201, or data relating to a contact on a screen included in the device 201. As regards the notion of continuity, by “continuously”, it is meant that measurements are taken according to a time interval called the refresh interval. Such an interval is in the order of one millisecond or a few seconds at most. In the example of a scheme based on the pressure of a finger on the screen, this amounts to measuring pressure of the finger on the screen at a frequency which is the inverse of the refresh interval.

Examples of user actions are:
Movement of a retina, in this case video data;
Movement of the device, in this case accelerometer data.
Movement of a finger on the screen, in this case pressure data;

A third step of the method consists in continuously transmitting 103 the data 204 acquired by the first device 201 to the second device 202. The transmission can be indirect with the server 203 as an intermediary between both devices or direct between both devices without an intermediary.

A fourth step consists in returning 104 the data 204 transmitted by the second device to the second user as a function of the time course of the non-audio data 204. According to one embodiment, the communication is considered to be established if the time course of the data 204 returned to the second user corresponds to a predetermined scheme for a predetermined period of time. The predetermined scheme results from an action of the first user of the first device 201 and may comprise at least one type of data from among the following data:
Video data in which the first user performs a movement according to predetermined instructions included in a zone 2013.1 of the memory 2013 of the device 201 or in the memory of the server 203. Such a scheme is referred to as an anatomical scheme.
A variation in the data from the accelerometer resulting from the first device 201 being moved along an axis predetermined by instructions included in a zone 2013.1 of the memory 2013 of the device 201 or of the memory of the server 203. This variation lasts for a predetermined period of time referred to as the establishment period of time, for example between 10 seconds and 60 seconds, preferably 30 seconds;
Pressure is maintained on a touch screen of the device 201 or on any other component capable of detecting pressure, for a predetermined period of time, preferably between 10 seconds and 60 seconds. This predetermined scheme enables a user in a critical condition, for example, or unable to speak and/or see, to give a sign of life to another user.
A change in position of the finger on the screen according to predetermined instructions included in a zone 2013.1 of the memory 2013 of the device 201 or in the memory of the server 203; for a predetermined period of time referred to as the establishment period of time, for example between 10 seconds and 60 seconds, which is preferably 30 seconds. In one alternative, the diagram can be pushed by the user of the other device, the aim then being to reproduce movements that appear on the screen.

According to one embodiment, the establishment of communication between both devices 201 and 202 is considered broken as soon as the user of device 201 interrupts the predetermined scheme. In this case, establishing a new communication between both devices 201 and 202 requires steps 101 to 104 to be repeated. An interruption of the scheme is, for example, the fact that one of both users removes their finger from the screen, closes their eyes, no longer moves the device, or moves the device in a manner not in accordance with the scheme.

According to another embodiment, the establishment of a communication between both devices 201 and 202 is considered to be broken as soon as the user of the device 201 interrupts the predetermined scheme for a period longer than a predetermined period called the interruption period of time, preferably between 500 milliseconds and 3 seconds.

According to yet another embodiment, the predetermined scheme is divided into two steps:
A first step, the period of time D1 of which is between 3 seconds and 6 seconds and preferably equal to 6 seconds, during which the non-audio data 204 received by the device 202 are returned entirely to the user without any particular processing;
Then a second step, the period of time D2 of which is between 7 seconds and 54 seconds and is preferably 24 seconds, during which the device 202 which receives the non-audio data 204 filters the data so as to return only part of it to the user of said device. For example, if the non-audio data 204 are a change in position of the finger on the screen following predetermined instructions included in a zone 2013.1 of the memory 2013 of the device 201 or in the memory of the server 203, said non-audio data 204 will be transmitted for a time D1, then the device 202 filters the data received by returning only the pressure that the user of the device 201 exerts on the screen with their finger to the user without returning the movement performed by the finger.

When the enhanced communication is considered to be established, according to one embodiment, the first device 201 can acquire and transmit data of one type among at least one of the following types: one or more images, voice data, or text, for example.

According to another embodiment, the enhanced communication is considered to be established if the steps of acquiring 102, transmitting 103 and returning 105 non-audio data 4 are simultaneously carried out by both devices 201 and 202 and if the time course of the non-audio data 4 corresponds to a predetermined scheme for a predetermined period of time, preferably between 10 seconds and 60 seconds, the predetermined schemes being mentioned previously. When enhanced communication is considered to be established in this embodiment, both devices 201 and 202 can transmit and receive images voice data or text for example.

According to the embodiment wherein the system 200 comprises a plurality of N mobile devices each used by a user, communication is considered to be established if the steps of acquiring 102, transmitting 103 and returning 105 non-audio data 4 are simultaneously carried out by the plurality of N devices and if the time course of the non-audio data 4 corresponds to a predetermined scheme for a predetermined period of time, preferably between 20 seconds and 60 seconds, the predetermined schemes being previously mentioned. When enhanced communication is considered to be established in this embodiment, the plurality of N devices may transmit and receive images, voice data or text for example.

1. A method for establishing enhanced communication between a first user of a first device and a second user of a second device, the method comprising:
establishing a bidirectional data exchange channel between the first device and the second device;
for at least the first device:
continuously acquiring non-audio data relating to an action of the first user;
continuously transmitting the data acquired by said first device to the second device;
returning the data transmitted by the second device to the second user as a function of the time course of the data;
wherein the communication is considered to be established if the time course of the data returned to the second user corresponds to a predetermined scheme for a predetermined period of time referred to as the establishment period of time, the establishment period of time being greater than or equal to 10 seconds.

2. The method according to claim 1, wherein establishing communication between the first and second devices is interrupted if the predetermined scheme is interrupted.

3. The method according to claim 1, wherein establishing communication between the first and second devices is interrupted if the predetermined scheme is interrupted for a predetermined period of time referred to as the interruption period of time.

4. The method according to claim 3, wherein if the period of time of the interruption of the scheme is less than the interruption period of time, then the establishment of the communication resumes.

5. The method according to claim 1, wherein when the enhanced communication is established, the user of the first communication device transmits data of the type formed by at least one of the following types: image, text, sound.

6. The method according to claim 1, wherein acquiring, transmitting and returning the non-audio data are carried out by the first and second devices and wherein the enhanced communication is considered to be established if the time course of the non-audio data received by the first and second devices corresponds to the predetermined scheme during the establishment period of time.

7. The method according to claim 1, wherein the continuously acquired data are of at least one type belonging to the set comprising the following elements:
video data, the predetermined scheme corresponding to an anatomical movement;
data from an accelerometer, the predetermined scheme corresponding to a movement of a device along at least one defined axis;
data relating to a contact on a screen included in either of the first and second devices and the predefined scheme being a time course of the contact, the time course being measured in pressure and/or location.

8. The method according to claim 1, wherein the establishment period of time is in the range of ten to sixty seconds.

9. The method according to claim 1, wherein the bidirectional data exchange channel between the first and second devices is established via a third device.

10. The method according to claim 1, wherein the communication between the first and second devices is established via the internet network.

11. The method according to claim 1, wherein the bidirectional data exchange channel between the first device and the second device is established according to the WebSocket® application protocol.

12. A system comprising a first device and a second device configured to implement the method according to claim 1.

13. The system according to claim 12, further comprising a third device configured to establish the bidirectional channel between the first device and the second device.

14. A non-transitory computer readable medium comprising instructions which, when the instructions are executed by a computer, cause the computer to implement the steps of the method according to claim 1.
